(19) United States
(12) Patent Application Publication
(10) Pub. No.: US 2006/0174202 A1
(43) Pub. Date: Aug. 3, 2006

(54) Input to interface element

(76) Inventor: Matthew Ryan Bonner, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/046,918

(22) Filed: Jan. 31, 2005

(51) Int. Cl. G06F 9/00

(52) U.S. Cl. 715/750; 715/764

(57) ABSTRACT

In one embodiment, a method determines whether a first input is directed at a first interface element defined in a hierarchical structure and a second input is directed at a second interface element defined in the hierarchical structure.

### BACKGROUND

Typical graphical user interfaces (GUIs) serially process input signals that are received from input devices such as a mouse or a keyboard. Serial processing of inputs to a multi-user GUI may, however, provide an inappropriate result. For instance, if two users simultaneously provide conflicting inputs to a GUI (e.g., by selecting both an “Okay” button and a “Cancel” button), the GUI processes the first input without regard for the second, conflicting, input. Accordingly, current GUI implementations may provide inappropriate results when dealing with multiple, conflicting inputs.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an embodiment of a method of determining conflicts between multiple inputs, according to an embodiment.

FIG. 2 illustrates portions of an embodiment of a graphical user interface, according to an embodiment.

FIG. 3 illustrates various components of an embodiment of a computing device which may be utilized to implement portions of the techniques discussed herein, according to an embodiment.

### DETAILED DESCRIPTION

Various embodiments for determining conflicts between multiple inputs are described. Some of the embodiments are envisioned to address the situations where multiple conflicting inputs (whether from a same user or multiple users) are received substantially simultaneously, such as selecting both a “Yes” and a “No” button in the same window at about the same time, for example, within a few seconds (e.g., in case of users with disabilities) or milliseconds of each other (or within other suitable and/or configurable time period(s)). In one embodiment, a method determines whether a first input is directed at a first interface element (e.g., a button) and a second input is directed at a second interface element (e.g., another button), where the first and second interface elements are defined in a same hierarchical structure (e.g., buttons that are part of a same window).

Determining Conflicts between Multiple Inputs

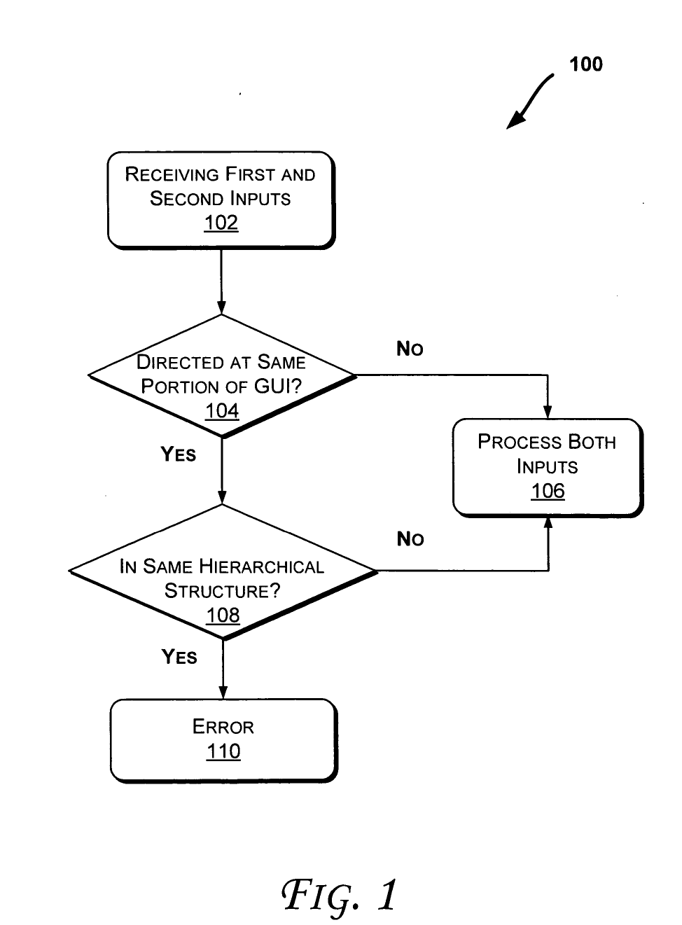

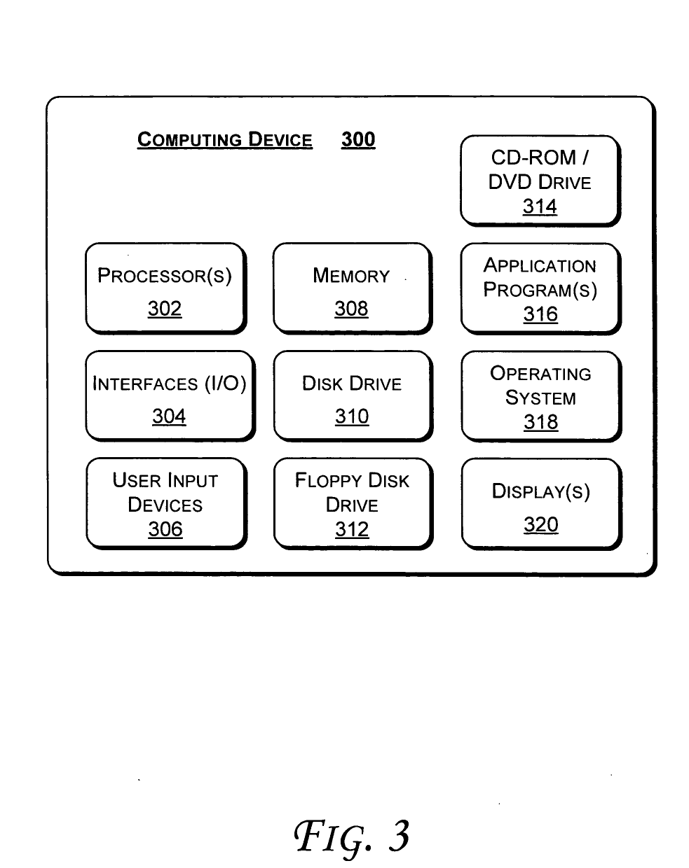

FIG. 1 illustrates a method 100 of determining conflicts between multiple inputs, according to an embodiment. In one embodiment, the method 100 is applied to a computer system that is capable of supporting multiple users such as the computer system 300 discussed with reference to FIG. 3.

The method 100 receives a plurality of inputs, e.g., a first input and a second input (102). The inputs may be received from a single user or multiple users. The inputs may be from a plurality of input devices such as those discussed with reference to FIG. 3. It is envisioned that each user may have access to its own input device(s) and provide inputs to the computer system 300. Also, it is envisioned that one or more users may utilize one or more of their fingers (e.g., in a touch screen implementation) to provide the inputs. In an embodiment, the inputs are received substantially simultaneously (e.g., within a few seconds or milliseconds of each other, or within other suitable and/or configurable time period(s)).

Furthermore, one or more applications running on the computer system (300) may be associated with a single user or a set of users. For example, one user may have ownership of an application (e.g., the user who launched the application) with other users having user rights. Accordingly, inputs from an unauthorized source (e.g., a user that has no rights or is not the owner of an application) may be ignored in an embodiment. Also, an error may be reported (e.g., by a window manager) if a user attempts to provide input to a non-authorized application.

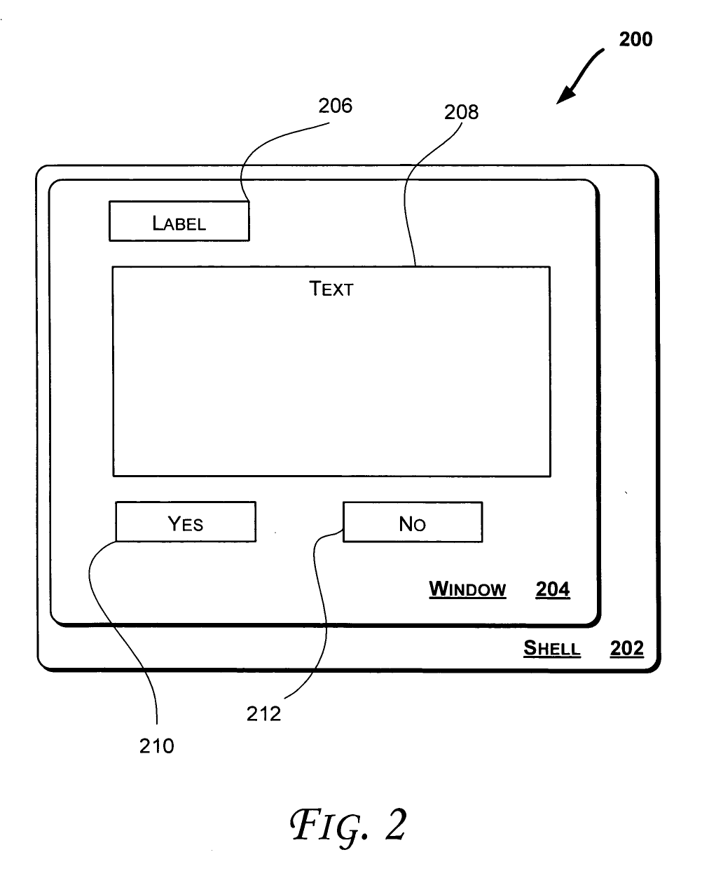

The method 100 further determines whether the inputs are directed at a same portion of a GUI (104). The same portion of the GUI may be a single window such as window 204 discussed with reference to FIG. 2. The GUI may include a plurality of windows. In one embodiment, any window that is partially overlapped by (or stacked on top on another window is considered to be inactive and any inputs to the inactive windows will be ignored. An inactive window may become active if it is selected (e.g., clicked on). A window manager may control the order of the window stacking. In an embodiment, all non-covered windows may be active, e.g., multiple users may each have one or more active windows on a display (e.g., 320 of FIG. 3).

If it is determined that the inputs are not directed at a same portion of a GUI (104), then the inputs are processed (106). Otherwise, it is determined whether the inputs are directed at a same hierarchical structure (108) or, in an embodiment, directed at user interface elements defined in a same hierarchical structure. One example of a hierarchical structure may refer to one or more user interface elements (such as buttons, fields, and the like, which are further discussed with reference to FIG. 2) that pertain to a same process or application. For example, the stage 108 may be performed by determining whether the received inputs are directed at two buttons on a same window (e.g., clicking both the “Okay” and “Cancel” buttons in a window). Accordingly, the definition of the user interface elements in the same hierarchical structure may indicate that the user interface elements are displayed in a same portion of a graphical user interface (e.g., buttons in the same window that are defined by the same data structure).

FIG. 2 illustrates portions of a graphical user interface 200, according to an embodiment. The GUI 200 includes one or more widgets. A widget (e.g., in an X windows system) is a data structure with a plurality of other data structures pointing to that same structure (widget), that is the owner of the plurality of data structures. Accordingly, for a given process or application, a top-level widget may be considered to be the root of a hierarchy formed by a plurality of other child widgets. The top-level application widget may then provide the interface to a window manager for the whole hierarchy. Hence, widgets may form a hierarchy because of their top-down operational relationship. Any function or procedure may create a widget and pass the parent widget for subsequent data structure definition(s). Accordingly, all children widgets of a given widget may be linked in some way to their respective parents, so that the hierarchical relationship between different widgets within a process or application is maintained. In an embodiment, each widget may know its immediate parent and the parent may know all its children.

The GUI 200 includes a shell widget 202. The shell widget 202 may be a root widget of one or more other widgets that pertain to the same process or application. The shell widget (202) may handle the interaction with the window manager (not shown) and act as the parent of all of the other widgets in the application. All of the other widgets created by the application may be created as descendents of the shell (202) such as a window 204 which displays information on a display (e.g., 320 of FIG. 3) to one or more users. The window widget 204 may in turn be the parent to other user interface elements such as a label 206, text data 208, and buttons 210 and 212.

The user interface elements discussed with reference to FIG. 1 may be GUI objects or widgets such as those discussed with reference to FIG. 2 including labels (206), buttons (210, 212), menus, dialog boxes, scrollbars, and text-entry or display areas (208). The hierarchical structure may be a structure in an object-oriented environment. Hence, the user interface elements may be widgets in a GUI environment.

In one embodiment, the stage 108 of FIG. 1 determines whether the user interface elements to which the inputs are directed share a same parent user interface element (e.g., same parent widget). The user interface elements may also share a same grandparent or shell user interface element.

Referring back to FIG. 1, if it is determined that the inputs are not directed at a same hierarchical structure (108), the inputs are processed (106). Otherwise, an error condition is indicated or reported. Accordingly, the method 100 determines whether a first input is directed at a first user interface element (e.g., a button) and a second input is directed at a second user interface element, where the first and second user interface elements are defined in a same hierarchical structure (e.g., are part of a same window and/or share a same parent widget). In an embodiment, the first input and the second input are received substantially simultaneously (e.g., within a few seconds or milliseconds of each other, or within other suitable and/or configurable time period(s)). This is envisioned to address the situations where multiple conflicting inputs (whether from a same user or multiple users) are received substantially simultaneously, such as selecting both a “Yes” and a “No” button in the same window at about the same time.

Exemplary Computing Environment

FIG. 3 illustrates various components of an embodiment of a computing device 300 which may be utilized to implement portions of the techniques discussed herein. In one embodiment, the computing device 300 can be used to perform the method of FIG. 1. The computing device 300 may also be used to provide access to and/or control of the GUI 200. The computing device 300 may further be used to manipulate, enhance, and/or store the images or windows (e.g., through a window manager) discussed herein.

The computing device 300 includes one or more processor(s) 302 (e.g., microprocessors, controllers, etc.), input/output interfaces 304 for the input and/or output of data, and user input devices 306. The processor(s) 302 process various instructions to control the operation of the computing device 300, while the input/output interfaces 304 provide a mechanism for the computing device 300 to communicate with other electronic and computing devices. The user input devices 306 can include a keyboard, touch screen, mouse, pointing device, and/or other mechanisms to interact with, and to input information to the computing device 300.

The computing device 300 may also include a memory 308 (such as read-only memory (ROM) and/or random-access memory (RAM)), a disk drive 310, a floppy disk drive 312, and a compact disk read-only memory (CD-ROM) and/or digital video disk (DVD) drive 314, which may provide data storage mechanisms for the computing device 300.

The computing device 300 also includes one or more application program(s) 316 (such as discussed with reference to FIGS. 1 and 2) and an operating system 318 which can be stored in non-volatile memory (e.g., the memory 308) and executed on the processor(s) 302 to provide a runtime environment in which the application program(s) 316 can run or execute. The computing device 300 can also include one or more integrated display device(s) 320, such as for a PDA, a portable computing device, and any other mobile computing device.

Select embodiments discussed herein (such as those discussed with reference to FIG. 1) may include various operations. These operations may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
determining whether a first input is directed at a first interface element defined in a hierarchical structure and a second input is directed at a second interface element defined in the hierarchical structure.

2. The method of claim 1, wherein the definition of the first and second interface elements in the hierarchical structure indicates that the first and second interface elements are displayed in a same portion of a graphical user interface.

3. The method of claim 2, wherein the same portion of the graphical user interface is a window.

4. The method of claim 2, wherein the graphical user interface comprises a plurality of windows.

5. The method of claim 4, wherein at least one of the plurality of windows is active.

6. The method of claim 4, wherein for each user one window is active.

7. The method of claim 1, wherein the first and second interface elements share at least one item selected from a group comprising a same parent interface element, a same grandparent interface element, and a same shell interface element.

8. The method of claim 1, wherein the first and second interface elements are selected from a group comprising a label, a button, a menu, a dialog box, a scrollbar, a text-entry area, and a display area.

9. The method of claim 1, wherein the first and second interface elements are widgets in a graphical user interface environment.

10. The method of claim 1, further comprising indicating an error condition if it is determined that the first input is directed at the first interface element and the second input is directed at the second interface element.

11. The method of claim 1, wherein the first input and the second input are received from a source selected from a group comprising a single user and multiple users.

12. The method of claim 1, wherein the first input and the second input are received substantially simultaneously.

13. The method of claim 1, further comprising ignoring one or more inputs received from one or more unauthorized sources.

14. The method of claim 1, wherein the hierarchical structure is a structure in an object-oriented environment.

15. The method of claim 1, further comprising processing the first and second inputs if the first and second interface elements are not defined in the hierarchical structure.

16. A system comprising:
a display to display a first interface element defined in a hierarchical structure and a second interface element defined in the hierarchical structure;
at least two input devices to receive a first input and a second input; and
a computing device configured to determine whether the first input is directed at the first interface element and the second input is directed at the second interface element.

17. The system of claim 16, wherein the definition of the first and second interface elements in the hierarchical structure indicates that the first and second interface elements are displayed in a same portion of a graphical user interface.

18. The system of claim 16, wherein the first and second interface elements share at least one item selected from a group comprising a same parent interface element, a same grandparent interface element, and a same shell interface element.

19. The system of claim 16, wherein the first and second interface elements are selected from a group comprising a label, a button, a menu, a dialog box, a scrollbar, a text-entry area, and a display area.

20. The system of claim 16, wherein the one or more input devices are controlled by one or more users.

21. The system of claim 16, wherein the first input and the second input are received substantially simultaneously.

22. The system of claim 16, wherein one or more inputs received from unauthorized sources are ignored.

23. The system of claim 16, wherein the display comprises a plurality of displays.

24. The system of claim 16, wherein the hierarchical structure is a structure in an object-oriented environment.

25. A computer-readable medium comprising:
stored instructions to determine whether a first input is directed at a first interface element defined in a hierarchical structure and a second input is directed at a second interface element defined in the hierarchical structure.

26. The computer-readable medium of claim 25, wherein the definition of the first and second interface elements in the hierarchical structure indicates that the first and second interface elements are displayed in a same portion of a graphical user interface.

27. The computer-readable medium of claim 25, further comprising stored instructions to indicate an error condition if it is determined that the first input is directed at the first interface element and the second input is directed at the second interface element.

28. The computer-readable medium of claim 25, further comprising stored instructions to ignore one or more inputs received from one or more unauthorized sources.

29. The computer-readable medium of claim 25, further comprising stored instructions to process the first and second inputs if the first and second interface elements are not defined in the hierarchical structure.

30. A method of resolving conflicts between a plurality of inputs to a graphical user interface, comprising:
step for determining whether a plurality of inputs are directed at interface elements; and
step for determining whether the interface elements are defined in a hierarchical structure.

31. The method of claim 30, wherein the step for determining whether the interface elements are defined in the hierarchical structure indicates that the interface elements are displayed in a same portion of a graphical user interface.

32. The method of claim 30, further comprising step for indicating an error condition if the plurality of inputs are directed at the interface elements.

33. The method of claim 30, further comprising step for ignoring one or more inputs received from one or more unauthorized sources.

34. An apparatus comprising:
means for determining whether a first input is directed at a first interface element and a second input is directed at a second interface element, and
means for defining the first and second interface elements in a hierarchical structure.

35. The apparatus of claim 34, further comprising means for indicating an error condition if it is determined that the first input is directed at the first interface element and the second input is directed at the second interface element.

36. The apparatus of claim 34, further comprising means for ignoring one or more inputs received from one or more unauthorized sources.
